(19) United States
(12) Patent Application Publication
(10) Pub. No.: US 2026/0187460 A1
(43) Pub. Date: Jul. 2, 2026

(54) SCALABLE AND INTERPRETABLE MACHINE LEARNING FOR SINGLE-CELL ANNOTATION

(71) Applicant: The Regents of The University of California, Oakland, CA (US)

(72) Inventors: Julian Lehrer, Oakland, CA (US); Vanessa Jonsson, Oakland, CA (US); Mohammed Mostajo-Radji, Oakland, CA (US)

(21) Appl. No.: 19/129,274

(22) PCT Filed: Nov. 13, 2023
(86) PCT No.: PCT/US2023/079489

§ 371 Date: May 12, 2025

Related U.S. Application Data
(60) Provisional application No. 63/383,388, filed on Nov. 11, 2022.

(51) Int. Cl. G06N 3/084; G06N 3/0455

(52) U.S. Cl. CPC G06N 3/084; G06N 3/0455

(57) ABSTRACT

A method can include receiving a labelled gene input data set; training a machine learning model to learn which genes distinguish cell type within the labelled gene input data set; and taking unlabeled single cell data and using the machine learning model to assign a label probability for each in the unlabeled single cell data.

### CROSS-REFERENCE TO RELATED APPLICATION

The present application claims priority to U.S. Provisional Application No. 63/383,388 entitled “SCALABLE AND INTERPRETABLE MACHINE LEARNING FOR SINGLE-CELL ANNOTATION”, and filed on Nov. 11, 2022. The entire contents of the above-listed application are hereby incorporated by reference for all purposes.

### ACKNOWLEDGEMENT OF GOVERNMENT SUPPORT

This invention was made with Government support under Grant No. 1RM1HG011543, awarded by the National Institutes of Health. The Government has certain rights in the invention.

### TECHNICAL FIELD

The present description relates generally to single-cell annotation and, more particularly, to the use of machine learning for single-cell annotation.

### BACKGROUND

Experiments in molecular and cellular biology today have become increasingly large and complex, with technological advances enabling high resolution, multi-modal omics measurements at the level of individual cells. The capacity to readily collect these datasets has contributed to unprecedented biological insight- and concurrently, a data deluge. Tasks such as cell annotation and cell state characterization increasingly necessitate automation, and while data driven methods aimed at inferring cell state from omics and image data are currently in development, a focus on robustness, scalability and interpretability are paramount.

### SUMMARY

Embodiments of the present disclosure are generally referred to herein as SIMS: an end-to-end modeling pipeline for discrete morphological prediction of single-cell data with minimal boilerplate and high accuracy. Several studies using SIMS have been performed and show the underlying model performs well in a variety of data-adverse conditions. Additionally, SIMS performs well between tissue samples and outperforms one of the most popular cell type classification algorithms on several benchmark datasets. Classification outputs can be directly characterized as a combination of sparse feature masks, allowing for interpretability at the level of individual samples. This interpretability recapitulates salient genes for classification by label, and globally across all samples. SIMS can become a useful tool in the field of single-cell data analysis.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates an example of the SIMS pipeline in accordance with certain implementations of the disclosed technology.

FIG. 2 illustrates an example of Metric Tracking via the SIMS package on wandb.ai for the Human Cortical Dataset.

FIGS. 3(a)-(d) illustrate an example of UMAP and label visualizations of dental data and retinal data: FIG. 3(a) illustrates UMAP projection of dental data colored by cell type; FIG. 3(b) illustrates distribution of labels for dental data; FIG. 3(c) illustrates UMAP projection of retina data colored by cell type; and FIG. 3(d) illustrates a distribution of labels for the retina dataset.

FIGS. 4(a)-(c) illustrate an example of UMAP and label visualizations of the Allen Brain Institute human cortical data: FIG. 4(a) illustrates UMAP projection colored by cell subtype; FIG. 4(b) illustrates a distribution of subtype labels; and FIG. 4(c) illustrates UMAP projection colored by cell type.

FIGS. 5(a)-(c) illustrate an example of UMAP and label visualizations of the Allen Brain Institute mouse cortical data: FIG. 5(a) illustrates UMAP projection of the colored by cell subtype; FIG. 5(b) illustrates a distribution of subtype labels; and FIG. 5(c) illustrates UMAP projection colored by main cell type.

FIGS. 6(a)-(c) illustrate an example of UMAP and label distributions of human human cortical data: FIG. 6(a) illustrates the UMAP projection of the human cortical data colored by cell subtype; FIG. 6(b) illustrates the distribution of these subtype labels; and FIG. 6(c) illustrates UMAP projection colored by cell supertype.

FIG. 7 illustrates an example of principal component visualizations of the three benchmark datasets from cortical tissue.

FIGS. 8(a)-(d) illustrate feature weights aggregated over all test samples for the dental and retina models: FIG. 8(a) illustrates a distribution of global feature weights for the trained dental model; FIG. 8(b) illustrates a matrix of normalized weights (input genes) across all samples on the test set; FIG. 8(c) illustrates a distribution of global feature weights for the trained retina model; and FIG. 8(d) illustrates a matrix of normalized feature weights for all samples on the test set.

FIGS. 9(a)-(d) illustrate an example of feature weights for models trained on the Allen Brain Institute human and mouse cortical datasets: FIG. 9(a) illustrates a distribution of global feature weights for the human cortical model, trained on all brain regions; FIG. 9(b) illustrates a matrix of normalized weights (input genes) across all samples on the human cortical test set; FIG. 9(c) illustrates a distribution of global feature weights for the mouse cortical model; and FIG. 9(d) illustrates a matrix of normalized feature weights for all samples on the mouse cortical test set.

FIG. 10 illustrates an example of top genes aggregated over cell subtype for the Allen Brain Institute mouse cortical data with C=42 cell types where each row represents a class label, and the columns are normalized feature mask values.

FIG. 11 illustrates an example of top genes aggregated over cell subtype for the Allen Brain Institute human cortical data with C=19 cell types where each row represents a class label, and the columns are normalized feature mask values.

FIGS. 12(a)-(b) illustrate an example of metric results for the SIMS pipeline trained on the Allen Brain Institute human MTG data and benchmarked on all available human brain tissue data: FIG. 12(a) illustrates balanced and weighted accuracy; and FIG. 12(b) illustrates aggregated F1 and median F1 scores.

FIGS. 13(a)-(b) illustrate an example of metric results for the SIMS pipeline trained on the Allen Brain Institute mouse VIC (Visual Cortex Region 1) data and tested on all other mouse brain tissue data: FIG. 13(a) illustrates balanced and weighted accuracy; and FIG. (b) illustrates aggregated F1 and median F1 scores.

FIGS. 14(a)-(d) illustrate an example of metrics for model trained on the Allen Brain Institute Human MTG data: FIG. 14(a) illustrates average of the median F1 score, across the final ten model epochs on the validation set for each ablative model; FIG. 14(b) illustrates validation loss as a function of the number of epochs trained; FIG. 14(c) illustrates median F1 score as a function of the number of epochs trained; and FIG. 14(d) illustrates weighted accuracy as a function of epochs trained.

FIGS. 15(a)-(d) illustrate an example of metrics for the SIMS model trained on the Allen Brain Institute Human MTG data with smaller training proportions: FIG. 15(a) illustrates average of the median F1 score, across the final ten model epochs on the validation set for each ablative model; FIG. 15(b) illustrates validation loss as a function of the number of epochs trained; FIG. 15(c) illustrates median F1 score as a function of the number of epochs trained; and FIG. 15(d) illustrates weighted accuracy as a function of epochs trained.

FIGS. 16(a)-(d) illustrate an example of metrics for model trained on the Allen Brain Institute Mouse cortex data: FIG. 16(a) illustrates average of the median F1 score, across the final ten model epochs on the validation set for each ablative model where each proportion p corresponds to a train/val/test split of pN cells; FIG. 16(b) illustrates validation loss as a function of the number of epochs trained; FIG. 16(c) illustrates median F1 score as a function of the number of epochs trained; and FIG. 16(d) illustrates weighted accuracy as a function of epochs trained.

FIG. 17 illustrates an example of cell types using the SIMS pipeline trained on inhibitory cortical neurons.

FIG. 18 illustrates an example of cell types of organoid data using the SIMS pipeline trained on primary data.

### DETAILED DESCRIPTION

Embodiments of the present disclosure are directed to a framework referred to herein as SIMS (Scalable, Interpretable Modeling for Single-Cell). Its development adhered to three guiding principles: Ease-of-use & development time; Interpretability; and Generalizability.

In the current state of single-cell transcriptomics, finding labeled examples from data requires much manual preprocessing, removal of technical variation (batch effect), clustering, and labeling with respect to a reference atlas. With the SIMS model, a user interface is sought such that the raw transcriptome from an experiment can be passed to a pretrained model and the cell type labels can be derived immediately with their associated labels. Additionally, this should require no manual preprocessing, normalization, correction of batch effect, or selecting variable genes on the user's part. Each lab will be able to train in-house models and save them in a “model zoo” for future use. To this end, a three-point API for model training has been developed.

### Concept and API

The SIMS pipeline can as an end-to-end development tool for building robust and sparse single-cell classifiers for discrete cell type prediction. SIMS has been developed with ease-of-use as a guiding principle, freeing up the end user from data preparation in exchange for rapid results for cell type inference.

First, a user defines a data module as an extension of the data module, which as its input takes in a list of data files containing the expression matrices and the associated label files. This data module can handle an arbitrary number of arbitrarily-sized datasets, even when the input genes do not match. This can be done by taking the intersection of features across multiple datasets, and only reading samples into memory from delimited files and HDF based files when needed for training. The label files are a delimited text file such that each row contains the associated label. The data module automatically numerically encodes the label set, computes the train, validation and test sets for training. Finally, the proportion of each label can be calculated, so samples can be weighted inversely to this number in the loss function to account for class imbalance.

Next, the model can be defined. The user can specify which metrics to track, which variant of stochastic gradient descent to use (or any other gradient-based optimizer), as well as methods for adaptive calculation of step size.

Finally, the trainer can be trained, which encapsulates all actual model training. The trainer connects to wandb.ai for live metric tracking, loss of both the training and validation step at each model epoch. Additionally, the trainer automatically handles distributed computation across multiple GPU's, moving gradients between CPU and GPU and handling device-specific movement of data.

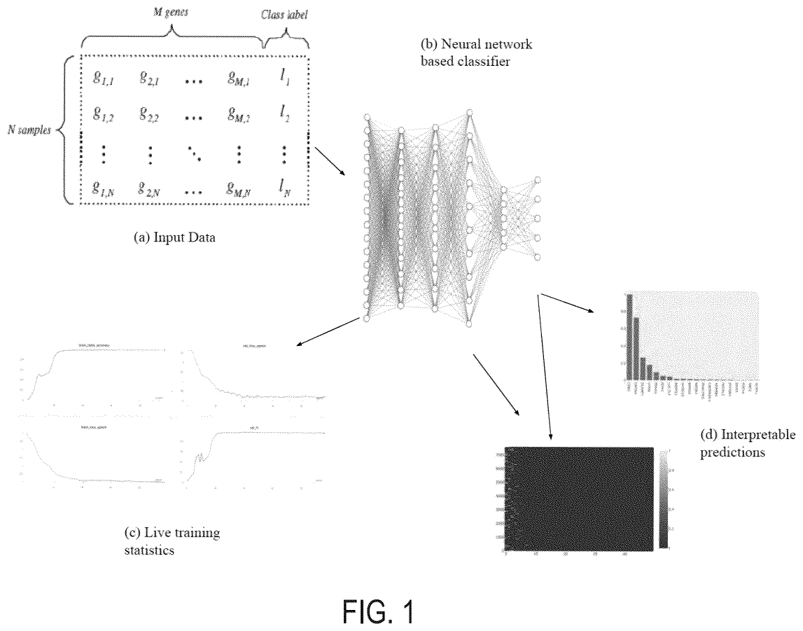

FIG. 1 illustrates an example of the SIMS pipeline. First, (a) normalized input data from expert annotations is input in the DataModule class. Next, the neural network (b) is defined with the chosen optimizer and training parameters. Live training statistics (c) can be viewed to understand training, validation and test performance. Finally, the feature masks are used to make interpretable predictions (d) on unseen data.

Implementations of SIMS can be modular and fast to develop with. To this end, training of multiple files of multiple data types and of arbitrary size is allowed. This is possible by reading in samples only as needed from delimited files. For HDF and files from binary data, the HDF distributed backend is used by default. This allows users to train models even when limited by memory constraints.

| | |
|---|---|
| 1 | from scsims import generate_trainer |
| 2 | trainer, model, module = generate_trainer( |
| 3 | datafiles=[‘data.h [symbol] d’], |
| 4 | labelfiles=[‘labels.csv’], |
| 5 | class_label=‘Cell Type’, |
| 6 | ) |
| 7 | trainer.fit(model, datamodule=module) |

[symbol]

indicates data missing or illegible when filed

This is the simplest case. However, SIMS is built in a modular way and therefore can be easily extended to handle custom data, model and trainer requirements.

| | |
|---|---|
| 1 | import [symbol] torch [symbol] lighting as p [symbol] |
| 2 | from [symbol] scsims import SIMSClassifier, DataModule |
| 3 | module = DataModule( |
| 4 | datafiles=[‘data.h [symbol] d’], |
| 5 | labelfiles=[‘labels.csv’], |
| 6 | class [symbol] label=‘Cell Type’, |
| 7 | ) |
| 8 | logger = p [symbol] loggers [symbol] WandbLogger( |
| 9 | project=“Single-Cell Classifier”, |
| 10 | name=name, |
| 11 | ) |
| 12 | early [symbol] stopping [symbol] callback = p [symbol] callbacks [symbol] EarlyStopping( |
| 13 | monitor=‘ [symbol] loss', |
| 14 | patience=4, |
| 15 | ) |
| 16 | trainer = p [symbol] Trainer( |
| 17 | gpu [symbol] = [symbol] , |
| 18 | logger=wa [symbol] db [symbol] logger, |
| 19 | gradient [symbol] clip [symbol] val=8.5, |
| 20 | callbacks=[ |
| 21 | early [symbol] stopping [symbol] callback, |
| 22 | ] |
| 23 | ) |
| 24 | model = SIMSClassifier( |
| 25 | input_dim=module [symbol] input [symbol] dim [symbol] |
| 26 | output_dim=module [symbol] output [symbol] dim [symbol] |
| 27 | ) |
| 28 | trainer [symbol] fit(model, datamodule=module) |

[symbol]

indicates data missing or illegible when filed

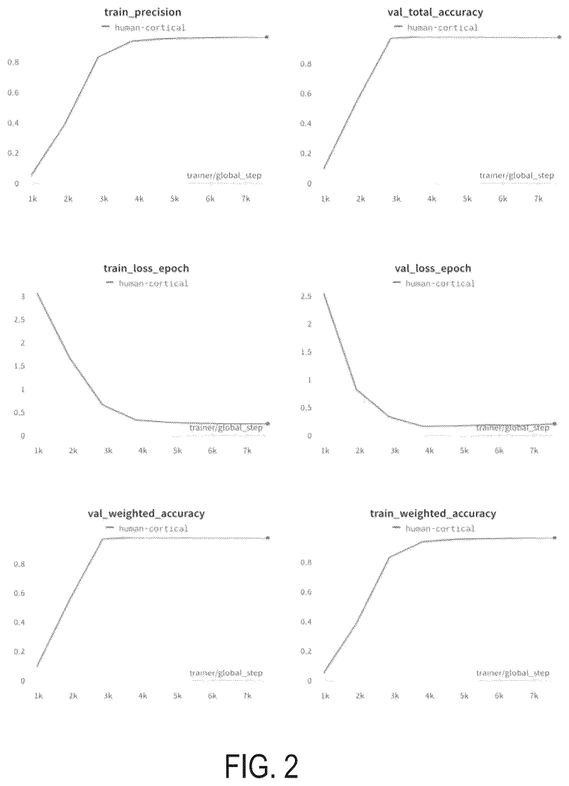

Unless specified otherwise, certain implementations of SIMS can also track over a dozen model training metrics for both the training and validation set on initial training. These metrics are calculated every mini-batch step, and aggregated appropriately at each epoch. FIG. 2 illustrates metrics tracked for the training of the human cortical tissue model from the Allen Brain Institute, visualized on wandb.ai.

This modular and high-level API allows end users to develop and deploy models quickly, and with minimal data preprocessing before the pipeline is used, as normalization is done within the SIMS pipeline and selecting highly variable genes via statistical tests is handled by the learned sparse feature masks.

### Results

The SIMS pipeline was used on multiple datasets with high accuracy and good generalization ability. Since transformer based architectures are usually data intensive to perform well, it was hypothesized that models trained on larger single-cell experiments would have better test accuracy. Surprisingly, accuracy and median f1 were high even with datasets with around 50 k cells. Additionally, as shown below, taking a small proportion of the initial dataset yielded little degradation in test accuracy. SIMS was initially benchmarked against human dental data, human cortical tissue from two datasets, human retinal tissue, and mouse cortical tissue.

| | | | # | # |
|---|---|---|---|---|
| Dataset | Source | Technology | Classes | Cells |
| Human Cortical | Allen Brain | SMART-Seq | 19 | 47432 |
| Model | Institute | v4 and 10x v3 | | |
| | | RNA-sequencing | | |
| Mouse Cortical | Allen Brain | SMART-Seq | 42 | 73347 |
| Model | Institute | v4 and 10x | | |
| | | chromium v2 | | |
| Human Retina | cells.ucsc.edu | 10x Chromium | 13 | 16446 |
| Model | [LLS⁺19] | v2 | | |
| Human Dental | cells.ucsc.edu | 10x Chromium | 9 | 41673 |
| Model | [KSK⁺20] | v2 | | |
| UCSF Cortical | cells.ucsc.edu | 10x Chromium | 28 | 168697 |
| Model | [BAML⁺20] | v2 | | |

Next, the distribution of the label sets across four of the datasets were visualized. Note that in biological tissue, there is often a dominant cell type and many minority classes. This is a problem for classification, since the model can achieve high unweighted accuracy by only predicting the majority classes—failing to predict rare cell types.

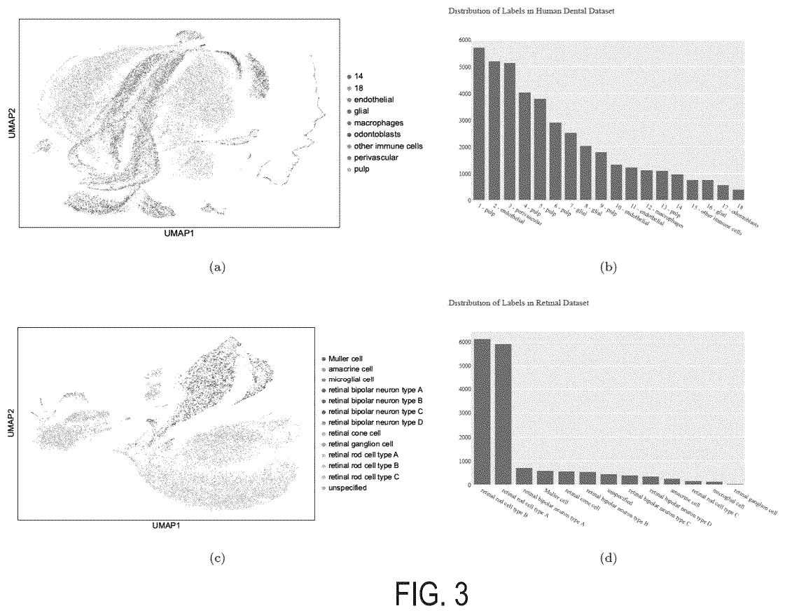

FIGS. 3(a)-(d) illustrate an example of UMAP and label visualizations of dental data and retinal data: FIG. 3(a) illustrates UMAP projection of dental data colored by cell type; FIG. 3(b) illustrates distribution of labels for dental data; FIG. 3(c) illustrates UMAP projection of retina data colored by cell type; and FIG. 3(d) illustrates a distribution of labels for the retina dataset.

Note that the label sets are highly skewed and long-tailed, where the majority class encompasses nearly half of all samples and the minority classes can be sparse. For this reason, we compute the f1 score of each class, and calculation the median of this. Intuitively, this tells us that the model will perform about that well half the time, and worse the other half. This is informative for when we have many rare cell types that could be ignored without much increase to the loss.

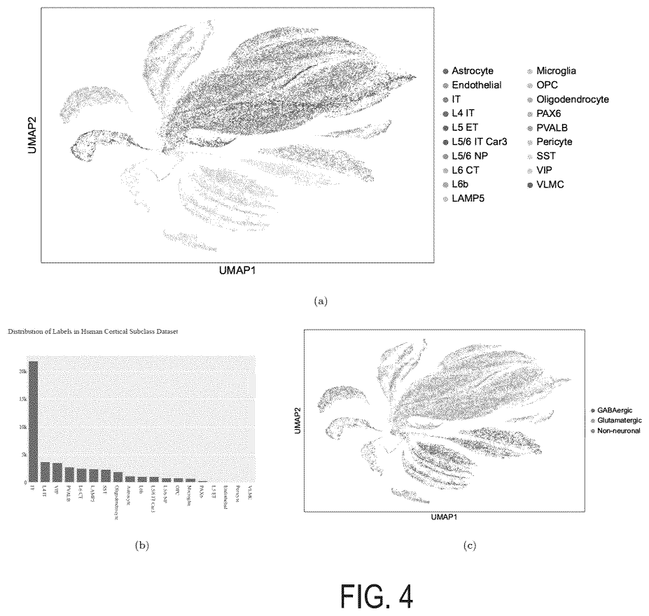

FIGS. 4(a)-(c) illustrate an example of UMAP and label visualizations of the Allen Brain Institute human cortical data: FIG. 4(a) illustrates UMAP projection colored by cell subtype; FIG. 4(b) illustrates a distribution of subtype labels; and FIG. 4(c) illustrates UMAP projection colored by cell type.

In the visualization of the human cortical data from the Allen Brain Institute, clear separation in the projection by class can be seen. For the granular annotations of cell subtype, there is little visual distinction in the projected data. Conversely, the larger cell phenotypes are visually distinct.

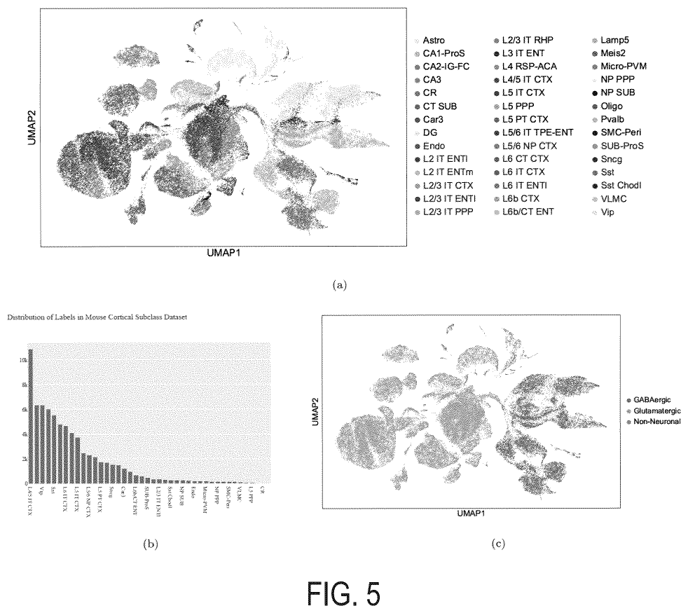

FIGS. 5(a)-(c) illustrate an example of UMAP and label visualizations of the Allen Brain Institute mouse cortical data: FIG. 5(a) illustrates UMAP projection of the colored by cell subtype; FIG. 5(b) illustrates a distribution of subtype labels; and FIG. 5(c) illustrates UMAP projection colored by main cell type.

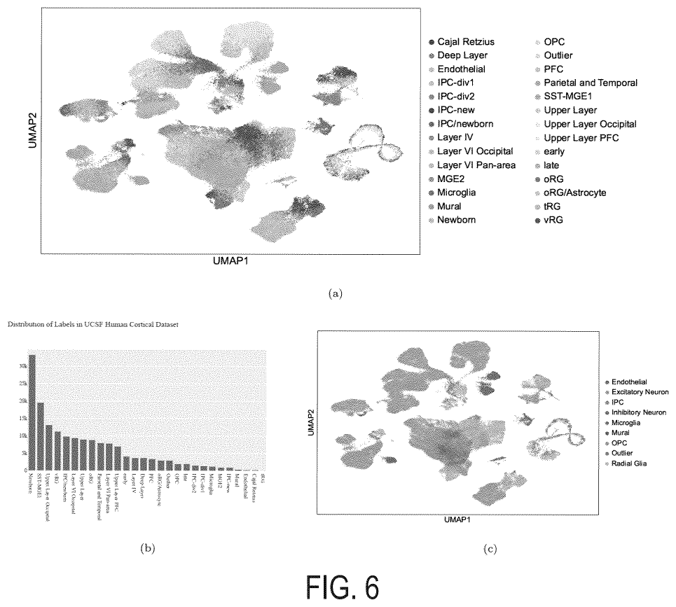

FIGS. 6(a)-(c) illustrate an example of UMAP and label distributions of human human cortical data: FIG. 6(a) illustrates the UMAP projection of the human cortical data colored by cell subtype; FIG. 6(b) illustrates the distribution of these subtype labels; and FIG. 6(c) illustrates UMAP projection colored by cell supertype.

Additionally, the data was projected onto the first and second principal components, and the proportion of linear variation explained by the first thirty was visualized. Interestingly, the models with the highest accuracy also have a high percentage of variance explained by the first few principal components.

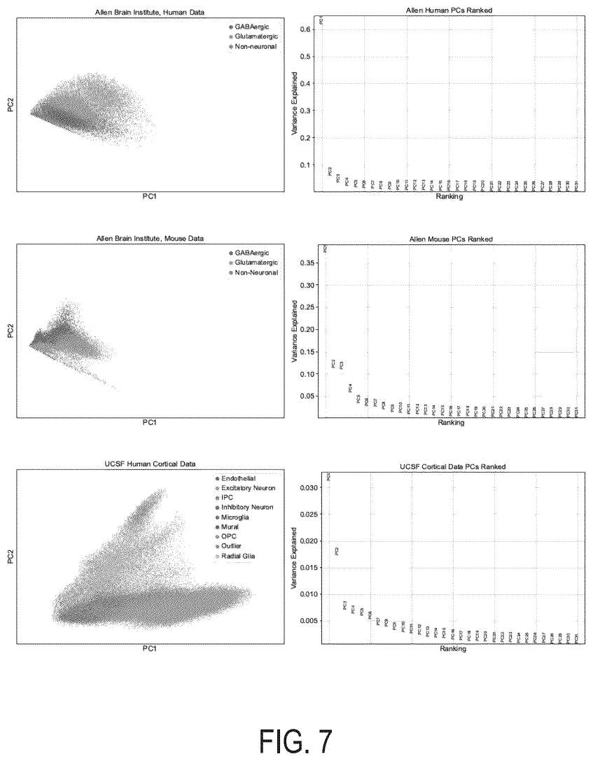

FIG. 7 illustrates an example of principal component visualizations of the three benchmark datasets from cortical tissue. The left column visualizes the data listed projected onto the first two principal components, where each point is colored by its major phenotype group. The right column ranks the first ten principal components for the dataset, ordered by the proportion of the linear variation explained by each.

Interestingly, there was noticed a relationship between the amount of linear variation explained by the first principal component and model performance. For data where the explained variance is high, the SIMS classifier performed more accurately, even when the granularity of annotation was high.

Each model was trained remotely on a distributed compute cluster via GPU, so all calculations were done with 32-bit precision. Metric results are shown below in Table 1, where precision, recall, and specificity were calculated using micro averaging:

TABLE 1

| Model | Accuracy | Weighted Accuracy | | Median F1 |
|---|---|---|---|---|
| Human Cortical Model | 0.9667 | 0.9812 | | .986 |
| Mouse Cortical Model | 0.9686 | 0.9755 | | 0.9659 |
| Human Retina Model | 0.857 | 0.92 | | 0.9219 |
| Human Dental Model | 0.9556 | 0.9598 | | 0.9733 |
| UCSF Cortical Model | 0.7354 | 0.7298 | | 0.7245 |
| Model | Precision | Recall | Specificity | Loss |
| Human Cortical Model | .9812 | 0.9812 | 0.999 | 0.2068 |
| Mouse Cortical Model | 0.9686 | 0.9686 | 0.9992 | 0.4153 |
| Human Retina Model | 0.9323 | 0.9223 | 0.922 | 0.2873 |
| Human Dental Model | 0.9801 | 0.9801 | 0.9975 | 0.2854 |
| UCSF Cortical Model | 0.7298 | 0.7298 | 0.9887 | 0.9097 |

For all models, the Adam optimizer was used, with a learning rate of r=0.01 and a weight decay of w=1e−3. The cross-entropy loss function was used, and weighted samples inversely proportional to their frequency in the dataset. Model convergence was assumed when the absolute validation accuracy did not increase for 4 epochs. A learning rate optimizer was used such that l←0.75l when the validation loss did not improve for twenty epochs.

In all cases, models reached convergence by the early stopping criterion on validation accuracy before the maximum number of epochs (500) was reached. Gradient clipping was used to avoid exploding gradient values. Although a train was used, validation and test split for reducing overfitting via hyperparameter tuning bias, the only hyperparameter tuned was the learning rate, once, to avoid divergence in the loss. Training took less than 20 epochs for most models. For all models, model training was found to be consistent and had less than three cases of suboptimal convergence due to poor initialization. The train, validation and test sets were stratified, meaning the distribution of labels is the same in all three (up to an error of one sample, when the number of samples for a given class was not divisible by three).

For all datasets, all models were trained using the most granular annotation available. As seen in Table 1, the SIMS pipeline performed well with varying levels of annotation granularity. Accuracy was the lowest on the UCSF cortical dataset with 28 classes. Sparse feature masks were used to visualize feature importance at a global level, sample level, and by class.

### Interpretability Analysis

Unlike other deep learning methods commonly used for single-cell label prediction, SIMS is one of the few that provides direct interpretability from the input features. Below are the top feature weights for the models trained on benchmarking data, on both a global basis and sample-wise basis for the test set.

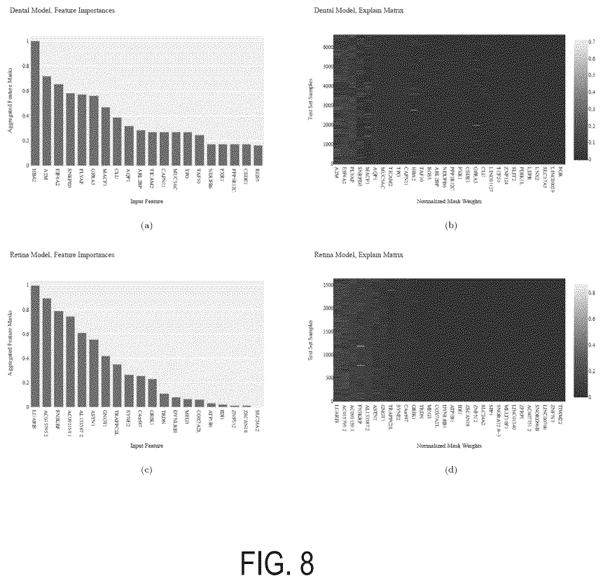

FIGS. 8(a)-(d) illustrate feature weights aggregated over all test samples for the dental and retina models: FIG. 8(a) illustrates a distribution of global feature weights for the trained dental model; FIG. 8(b) illustrates a matrix of normalized weights (input genes) across all samples on the test set; FIG. 8(c) illustrates a distribution of global feature weights for the trained retina model; and FIG. 8(d) illustrates a matrix of normalized feature weights for all samples on the test set.

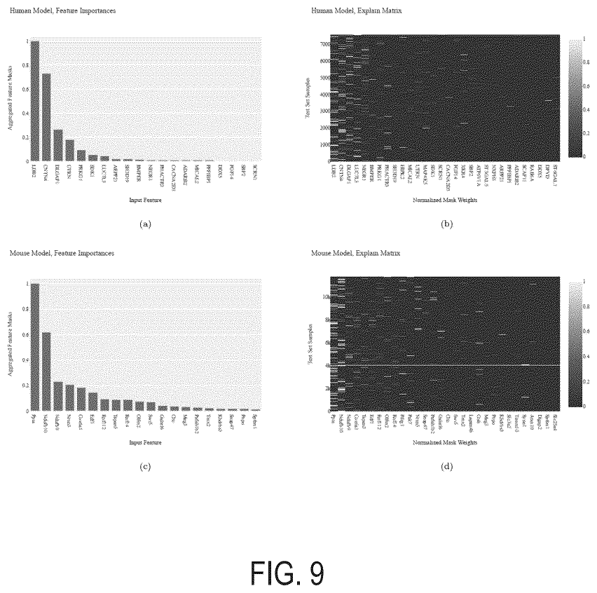

FIGS. 9(a)-(d) illustrate an example of feature weights for models trained on the Allen Brain Institute human and mouse cortical datasets: FIG. 9(a) illustrates a distribution of global feature weights for the human cortical model, trained on all brain regions; FIG. 9(b) illustrates a matrix of normalized weights (input genes) across all samples on the human cortical test set; FIG. 9(c) illustrates a distribution of global feature weights for the mouse cortical model; and FIG. 9(d) illustrates a matrix of normalized feature weights for all samples on the mouse cortical test set.

For FIGS. 8 and 9, all the feature masks were aggregated over all test samples. Then, we normalized by the largest weight since the relative scale between models isn't meaningful, but rather the proportion of each weight. Finally, the top twenty features used were visualized. On the right is the so-called “explain matrix” sorted by feature sum across all samples, for the test set. This allows one to visualize the fact that across different samples, different genes are being used for classification. There is direct interpretability on the input features.

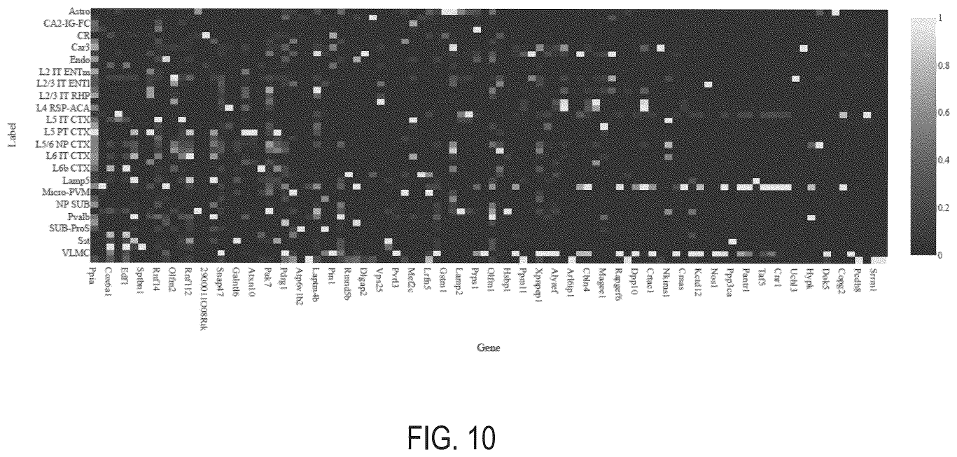

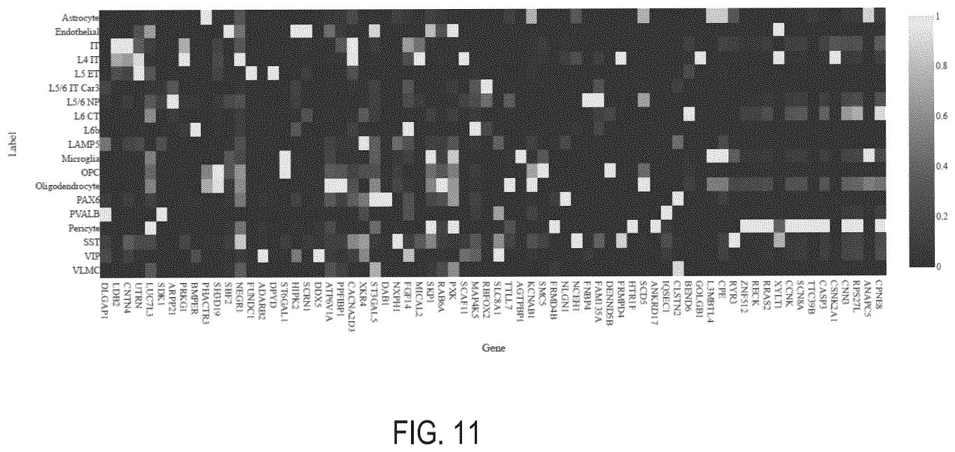

The sample-wise explain matrices were then partitioned by class, then the rows were averaged. This was aggregated in a new table, and finally each column (gene) was normalized by dividing by its maximum. The top 50 columns were visualized by norm. Although some genes may be used by only a few classes and therefore have small total column sum, FIGS. 10 and 11 serve to show the different distributions of genes across classes.

FIG. 10 illustrates an example of top genes aggregated over cell subtype for the Allen Brain Institute mouse cortical data with C=42 cell types. Each row represents a class label, and the columns are normalized feature mask values.

FIG. 11 illustrates an example of top genes aggregated over cell subtype for the Allen Brain Institute human cortical data with C=19 cell types. Each row represents a class label, and the columns are normalized feature mask values.

By calculating the weights across the sparse feature masks, the contribution of each input feature to the total classification process can be measures, while also promoting sparsity in downstream weights, allowing for a smaller and more computationally efficient model without sacrificing accuracy.

### Generalization Capability

In addition to performing well on the test set, it is desired that the SIMS model perform well on data from different studies. Although the test set is a proxy for unseen data, the distribution is assumed to be the same as the data on which the model is trained. However, for data collected from different studies with technical variation, this assumption may not hold. An important test for real-world use case is the ability for a model to perform well on data with a potentially different input distribution. The Allen Brain Institute data comprises multiple tissue samples from multiple experiments, and in total samples tissue from several parts of the human and mouse brain. To test the ability of the SIMS model to generalize to other datasets, a model was first trained on the human middle temporal gyrus from the Allen data, and tested against all other tissue samples from the Allen human data.

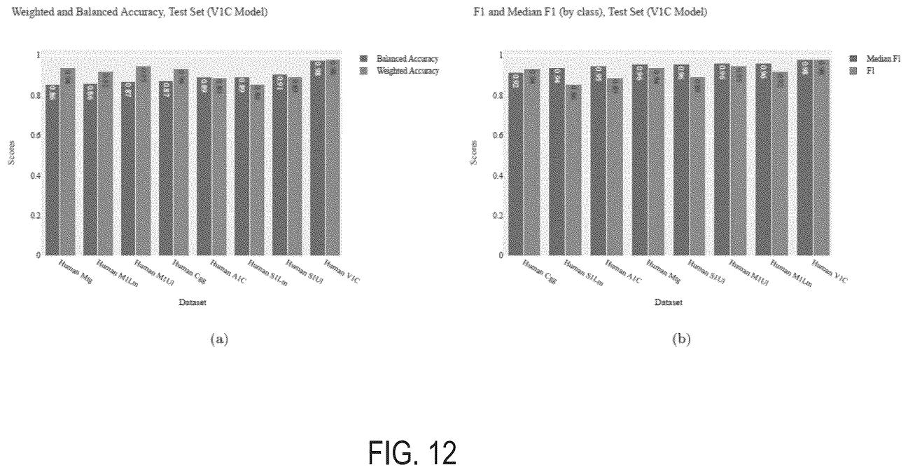

FIGS. 12(a)-(b) illustrate an example of metric results for the SIMS pipeline trained on the Allen Brain Institute human MTG data and benchmarked on all available human brain tissue data: FIG. 12(a) illustrates balanced and weighted accuracy; and FIG. 12(b) illustrates aggregated F1 and median F1 scores.

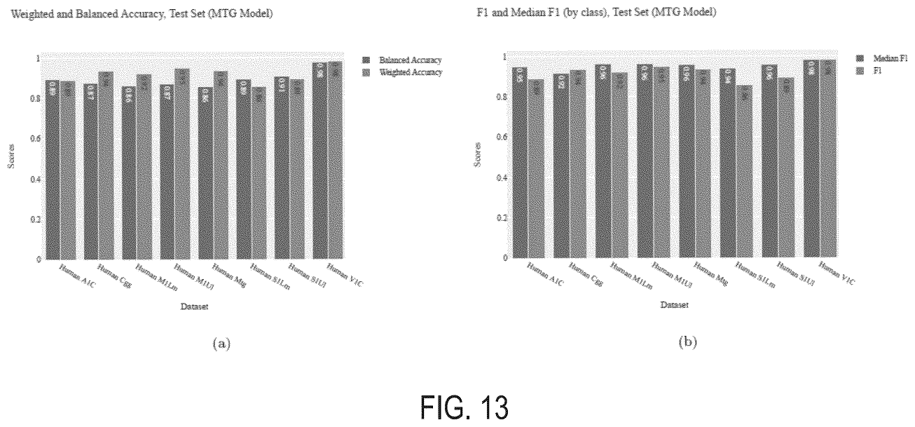

FIGS. 13(a)-(b) illustrate an example of metric results for the SIMS pipeline trained on the Allen Brain Institute mouse VIC (Visual Cortex Region 1) data and tested on all other mouse brain tissue data: FIG. 13(a) illustrates balanced and weighted accuracy; and FIG. (b) illustrates aggregated F1 and median F1 scores.

In general, the model performs well when predicting labels from different tissue samples. For both models trained on MTG and VIC data respectively, weighted accuracy is lowest against the SILm tissue sample. The median F1 for both models is lowest against cGG tissue samples.

### Ablative Studies

In machine learning, an ablation is the removal of a component of a machine learning system in order to test robustness to different conditions. By restricting particular parts of the modeling pipeline, glean insight into performance causality, guiding future model research and data experimentation. With SIMS, an ablative study was performed on model capacity as a function of dataset size. Since transformer-based architectures in computer vision and natural language tasks tend to require large training sets to obtain accurate results, it was hypothesized that progressively restricting the size of the training set would lead to a fast drop-off in test accuracy. Instead, results indicated the SIMS model yielded comparable train and test errors for up to a 90% data truncation when trained on the Allen Brain Institute data.

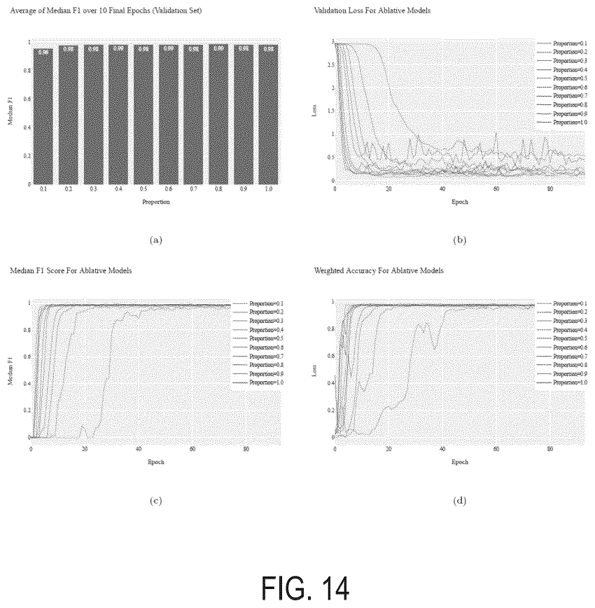

FIG. 14 illustrates an example of metrics for model trained on the Allen Brain Institute Human MTG data. Total number of cells in initial training set was N=47432 and M=19 classes. Each proportion p corresponds to a train/val/test split of pN cells. Data was stratified in the train/val/test split, and each split was determined with a deterministic seed for all runs. (a) Average of the median F1 score, across the final ten model epochs on the validation set for each ablative model. Each proportion p corresponds to a train/val/test split of pN cells. (b) Validation loss as a function of the number of epochs trained. (c) Median F1 score as a function of the number of epochs trained. (d) Weighted accuracy as a function of epochs trained.

Interestingly, there was only a 2% difference in median F1 score from the smallest training set to the largest training set, when tested against unseen samples from the same experiment. Since the difference in training time may be worth the trade-off in capability for some use cases, a test was performed as to how small of a dataset would be acceptable for good in-distribution performance. Below, one can see that a sample proportion of p=0.09≈4000 cells with 19 cell types gives suitable performance on the test set of 900 cells. However, since the datasets were small, the splits could not be stratified.

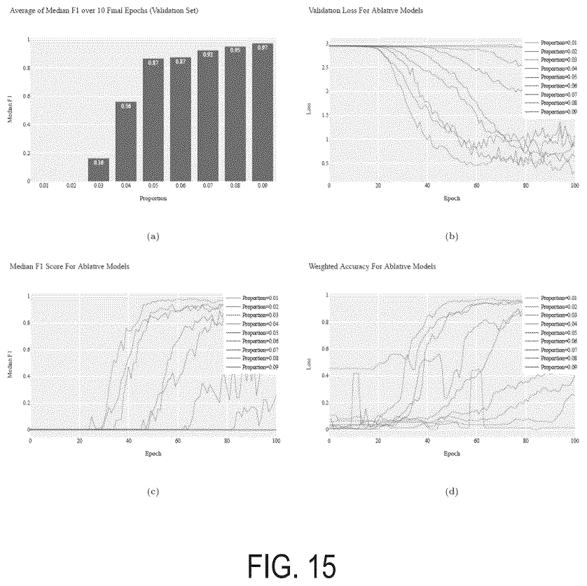

FIG. 15 illustrates an example of metrics for the SIMS model trained on the Allen Brain Institute Human MTG data with smaller training proportions. The train/val/test splits were stratified when the dataset was large enough to do so, and each split was determined with a deterministic seed for all runs. (a) Average of the median F1 score, across the final ten model epochs on the validation set for each ablative model. Each proportion p corresponds to a train/val/test split of pN cells. (b) Validation loss as a function of the number of epochs trained. (c) Median F1 score as a function of the number of epochs trained. (d) Weighted accuracy as a function of epochs trained.

To test if this data efficiency holds for more granular annotations, the same experiment was performed on the Allen Brain Institute Mouse data with N=42 classes.

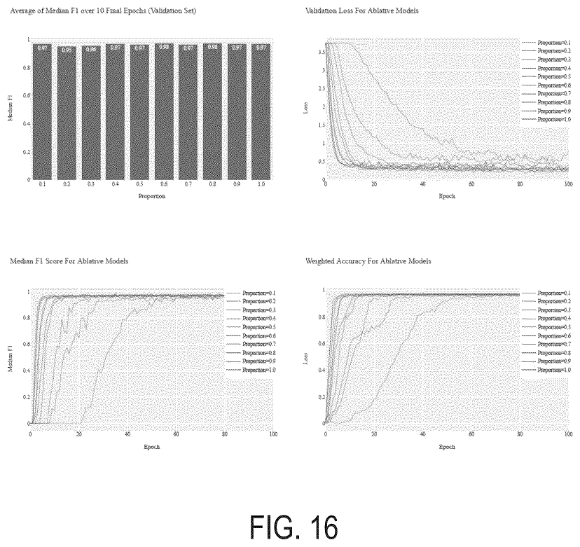

FIG. 16 illustrates an example of metrics for model trained on the Allen Brain Institute Mouse cortex data. Total number of cells in initial training set was N=73347 and M=42 classes. (a) Average of the median F1 score, across the final ten model epochs on the validation set for each ablative model. Each proportion p corresponds to a train/val/test split of pN cells. (b) Validation loss as a function of the number of epochs trained. (c) Median F1 score as a function of the number of epochs trained. (d) Weighted accuracy as a function of epochs trained.

Even with increased annotation granularity, the model performed well on unseen data from the same initial dataset. In both experiments, there is a monotonic relationship between convergence time and dataset size, whereas the size of the dataset decreases the number of epochs until convergence increases. Overall, it was found that SIMS performed well when classifying cells across multiple tissue types. Although these datasets were collected across multiple experiments, they are all from the Allen Brain Institute.

Automated cell type identification has many current tools available. Here, the focus is on tools written in Python as Python tends to integrate best with the current existing tools. Some tools use a support vector machine with a linear kernel to define multiple separating hyperplanes for classification. Other methods use a support vector machine with a radial kernel for improved results. Simpler algorithms use a priori known markers to assign cell types to differentially expressed genes for each cell. A neural-network based classifier in single-cell uses a fully-connected feedforward neural network on PCA space for classification. Other tools use generative neural networks to learn compressed representations of the inputs, and use Bayesian modeling to generate posterior probabilities for each cell. A popular method in the current single-cell pipelines is scANVI, due to its ease of use and ability to both build joint embeddings and calculate differentially expressed genes.

To validate the SIMS pipeline as a valid method for supervised label classification the same datasets were benchmarked under the exact same train, validation and test splits against the scANVI method. To be as unbiased as possible, we trained both the initial scVI model to generate the latent cell embedding and the scANVI semi-supervised classification model for 150 epochs with early stop-ping on validation accuracy, in order to guarantee convergence without overfitting. In both cases, the model did stop before 150 epochs with the stopping criterion.

(a) Metrics on test set, mouse cortical dataset from
the Allen Brain Institute dataset. C = 42 classes

| | scANVI | SIMS |
|---|---|---|
| Accuracy | 0.913 | 0.976 |
| Median F1 | 0.0 | 0.9834 |

(b) Metrics on test set, human cortical dataset from
the Allen Brain Institute dataset. C = 19 classes

| | scANVI | SIMS |
|---|---|---|
| Accuracy | 0.974 | 0.9812 |
| Median F1 | 0.9819 | 0.9868 |

(c) Metrics on test set, humans cortical dataset from the UCSF
Bhaduri dataset [BAML⁺20]. C = 28 classes.

| | scANVI | SIMS |
|---|---|---|
| Accuracy | 0.5687 | 0.7354 |
| Median F1 | 0.0 | 0.7245 |

(d) Metrics on test set, retina dataset from
[LLS⁺19]. C = 13 classes.

| | scANVI | SIMS |
|---|---|---|
| Accuracy | 0.93123 | 0.9223 |
| Median F1 | 0.9375 | 0.9223 |

The pancreas dataset was scaled so values were not raw counts. Therefore, the scANVI pipeline wasn't used. One can note that SIMS outperforms scANVI in all but one case, but the discrepancy in accuracy and median F1 of less than one percent is likely due to noise from the train and test splits. Additionally, in a case of deep annotation, SIMS outperforms by nearly 17%. In the two final cases, SIMS outperforms scANVI by approximately five and one percent.

### Inference on Tissue Cultures

A primary use case for the both 3D organoid models and 2D human induced pluripotent stem cells is characterizing the growth of human organs modeled in vitro. In a goal to build a good 3D model of the human brain via organoids in vitro, an important step is making sure the distribution of cells is the same in both primary tissue sample and organoids.

However, the differences between cell feeding times in stem cell organoids changes the transcriptomic characterization of cells. Although these changes are limited to small number of genes, these molecular changes make the clustering process difficult and therefore distinct cell types difficult to detect. Machine learning models, however, can perform inference on transcriptomic data. In the case of the SIMS model, it was verified that no stress genes had nonzero weight in the feature masks. Below are experimental results in which cells from mouse embryos were transplanted into human cortical organoids. A priori, these cells were known to be of inhibitory neuron origin. Using the SIMS pipeline, a model was trained on a large dataset of inhibitory neurons, and this model was used to infer cell type within the transplanted cells.

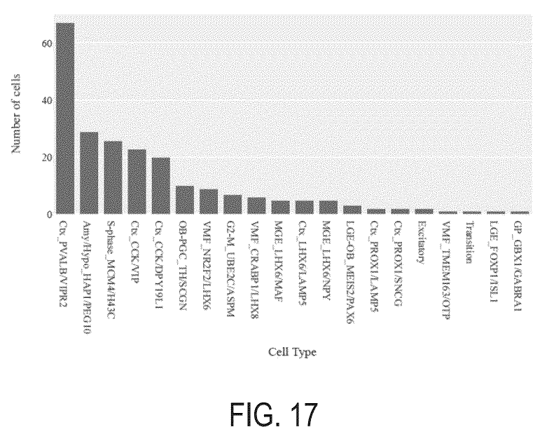

FIG. 17 illustrates an example of cell types using the SIMS pipeline trained on inhibitory cortical neurons.

These results are expected biologically, as all cells transplanted were dissociated from mouse cortex. Additionally, the cells were known to be inhibitory. This means the model definitely misclassified the four cells predicted as excitatory neurons.

In one instance, samples were taken from both primary and organoid tissues. Cell types for the primary tissue were inferred. However, due to cell stress in a subset of genes, clustering was difficult to perform, and distinct cell subtypes were not able to be inferred. Using the explainability of the SIMS model, it was confirmed that the genes associated with cells stress were not used for prediction. Therefore, inference using the SIMS model is more robust to cell stress, since the model does not directly use that part of the transcriptome. The inferred cell types are visualized below.

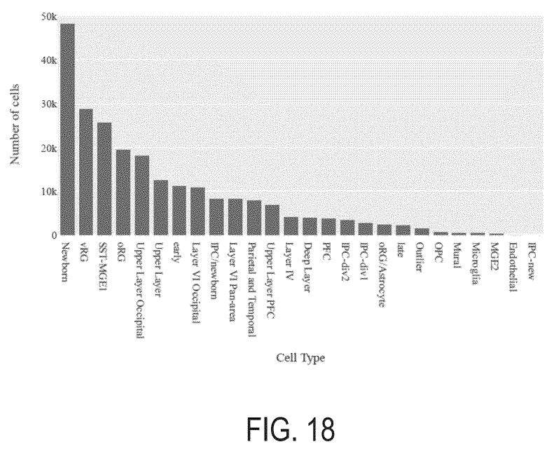

FIG. 18 illustrates an example of cell types of organoid data using the SIMS pipeline trained on primary data.

As biologists seek to understand the functionality and relation of individual cells both in vivo and in vitro, single-cell RNA-seq allows for transcriptomics at unprecedented resolution. By measuring mRNA levels in each cell, SIMS can characterize the distribution of discrete and continuous morphological properties, allowing important insight into biological function. However, as these experiments increase in size, the need for an automated pipeline of key analyses is critical for three major reasons.

Firstly, these computational steps often require expert domain knowledge for cluster annotation, limiting rapid analyses for experimental prototyping. Secondly, the process is both manual and recursive. This leads to potential redundancy by repeating statistically challenging and automatable steps. Thirdly, as 2D dissociated tissue models and 3D organoid models become increasingly important for data-driven biological discovery, clustering and marker gene an-notation from molecular data can be impeded by cell stress and technical variability.

For this reason, interpretable and powerful models built on high-quality ground truth data will become increasingly important for phenotypic and morphological predictions. While current methods often rely on a priori known markers or variational autoencoders for isolating biological variability and classification, SIMS turns to an interpretable deep learning approach, focusing on both data efficiency, robustness, and ease-of-use.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, and so on, that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
receiving a labelled gene input data set;
training a machine learning model to learn which genes distinguish cell type within the labelled gene input data set; and
taking unlabeled single cell data and using the machine learning model to assign a label probability for each in the unlabeled single cell data.

2. The method of claim 1, wherein the labelled gene input data set includes N samples having M genes and a class label.

3. The method of claim 1, wherein the labelled gene input data set is normalized.

4. The method of claim 1, wherein the labelled gene input data set includes delimited tabular data.

5. The method of claim 1, wherein the machine learning model is a neural network based classifier.

6. The method of claim 5, wherein the neural network based classifier is a transformer-based neural network.

7. The method of claim 5, wherein the neural network is defined with chosen optimizer and training parameters.

8. The method of claim 1, wherein the output includes a list of probabilities for each training/predicted label for each cell.

9. The method of claim 1, further comprising using feature masks to make interpretable predictions on unseen data.

10. The method of claim 1, further comprising determining and providing live statistics on how the machine learning model is performing during the training.

11. The method of claim 1, wherein the machine learning model is a dental or a retina model.

12. The method of claim 1, further comprising aggregating feature weights over all test samples for dental and retina models.

13. The method of claim 1, further comprising defining the model by specifying metrics to track.

14. The method of claim 1, further comprising defining the model by specifying which variant of stochastic gradient descent to use.

15. A non-transitory storage medium storing executable instructions that, when executed by a processor, cause the processor to perform the method of claim 1.
